(19) United States
(12) Patent Application Publication
(10) Pub. No.: US 2008/0279619 A1
(43) Pub. Date: Nov. 13, 2008

(54) TRAILER HITCH SAFETY DEVICE

(76) Inventors: Buddy Miller, Vista, CA (US); Mary D. Miller, Vista, CA (US)

Correspondence Address: HOVEY WILLIAMS LLP, 10801 Mastin Blvd., Suite 1000, Overland Park, KS, 66210, US

(21) Appl. No.: 11/745,981

(22) Filed: May 8, 2007

(51) Int. Cl. B60D 1/28

(52) U.S. Cl. 403/164

(57) ABSTRACT

A safety device for connection between a tongue of a trailer and a hitch of a vehicle includes an elongate arm and first and second ball joint sections located at opposite ends of the elongate arm. Each ball joint section includes a bearing cage formed in the elongate arm and a spherical bearing member positioned within the bearing cage. One of the spherical bearing member connects to the trailer tongue and the other spherical bearing member connects to the hitch. In this manner, relative movement between the trailer tongue and hitch causes rotation of the first and second spherical bearing members during towing along uneven surfaces to maintain a safety connection between the trailer tongue and hitch.

### BACKGROUND OF THE INVENTION

1. Field of the Invention

This invention relates to trailer hitches, and more particularly to a safety device connectable between a hitch of a vehicle and a tongue of a trailer for preventing separation of the trailer from the vehicle.

2. Discussion of Prior Art

Conventional trailer hitches for most passenger vehicles include a support frame or plate that is typically secured to either a chassis or rear bumper of a towing vehicle. A ball for engagement by the tongue of a trailer is formed at an upper end of a shank portion. A lower end of the shank portion is in turn mounted to the support frame or plate. When connecting a trailer to a vehicle, the ball is received in a socket formed in the trailer tongue. The socket is typically expandable to fit over the ball and includes a locking mechanism that can be manipulated to retract and lock the socket to the ball. Once locked, the tongue of the trailer is rotatable on the ball to a limited extent about three perpendicular axes of rotation to thereby accommodate deviations in the road surface such as bumps, dips, hills, vehicle turning, variations in trailer and vehicle loading, and so on.

Ball and socket type trailer hitching systems are prevalent with passenger vehicles and the trailers that they are designed to pull. Although these types of trailer hitching systems are quite popular due to their ease of use and convenience, they may pose a danger to property and life when improperly installed or due to mechanical failure. For example, the locking mechanism on the trailer tongue can work loose or malfunction during trailer towing. Consequently, the trailer may separate from the towing vehicle thereby posing a danger to the trailer, any equipment loaded on the trailer, the towing vehicle and persons within the vehicle, as well as bystanders, other vehicles, and static structures that may be in the run-away path of the trailer. The trailer may also separate from the towing vehicle when the tongue and ball are improperly matched. Because of this danger, a number of states require that the ball and socket hitch be supplemented by safety chains that connect between the trailer and the vehicle so that the trailer and towing vehicle remain connected during separation of the ball and socket. Thus, it is anticipated that the driver of the towing vehicle will retain at least some control over movement of the trailer and will be able to bring both the trailer and towing vehicle to a safe stop. Unfortunately, safety chains are inadequate in many instances to provide the necessary control for protecting both life and property. Safety chains must be connected with some slack between the vehicle and trailer in order to negotiate turns. Because of the flexibility and slack in the chains, control of the towing vehicle and trailer may be very limited when the ball and socket are separated.

### SUMMARY OF THE INVENTION

According to the invention, a safety device for connection between a tongue of a trailer and a hitch of a vehicle comprises an elongate arm and first and second ball joint sections located at opposite ends of the elongate arm. The first and second ball joint sections include first and second bearing cages, respectively, located in the elongate arm and first and second substantially spherical bearing members positioned within the first and second bearing cages, respectively, for rotation relative thereto. The first spherical bearing member is adapted for connection to one of the tongue and the hitch, while the second spherical bearing member is adapted for connection to the other of the tongue and the hitch. In this manner, relative movement between the trailer tongue and hitch causes rotation of the first and second spherical bearing members.

Further according to the invention, a safety device for connection between a tongue of a trailer and a hitch of a vehicle comprises an elongate arm with a first arm portion adjustably connected to a second arm portion for adjusting a length of the elongate arm, and a ball joint section connected to each of the first and second arm portions. Each ball joint section includes a bearing cage located in the respective arm portion and a bearing member positioned in the bearing cage for rotation relative thereto. Each bearing member is adapted for connection to one of the tongue and the hitch. In this manner, relative movement between the trailer tongue and hitch causes rotation of the first and second spherical bearing members.

Other aspects and advantages of the present invention will be apparent from the following detailed description of the preferred embodiments and the accompanying drawing figures.

### BRIEF DESCRIPTION OF THE DRAWING FIGURES

Preferred embodiments of the invention are described in detail below with reference to the attached drawing figures, wherein:

FIG. 1 is a side elevational exploded view of a trailer hitch safety device according to the invention;

FIG. 2 is a top plan view of a connecting arm that forms part of the trailer hitch safety device of FIG. 1;

FIG. 3 is a rear elevational view of the trailer hitch safety device according to the invention;

FIG. 4 is a side elevational view of the trailer hitch safety device connected between a trailer tongue and a trailer hitch of a towing vehicle;

FIG. 5 is a side elevational view of the trailer hitch safety device with the trailer tongue and hitch oriented at different angles with respect to a direction parallel to a vehicle travel direction; and

FIG. 6 is a rear elevational view of the trailer hitch safety device with the trailer tongue and support structure oriented at different angles with respect to a direction transverse to a vehicle travel direction.

It is noted that the drawings of the invention may not necessarily be to scale. The drawings are intended to depict only typical embodiments of the invention, and therefore should not be considered as limiting the scope of the invention. The invention will now be described with additional specificity and detail through the accompanying drawings.

### DETAILED DESCRIPTION OF THE PREFERRED EMBODIMENTS

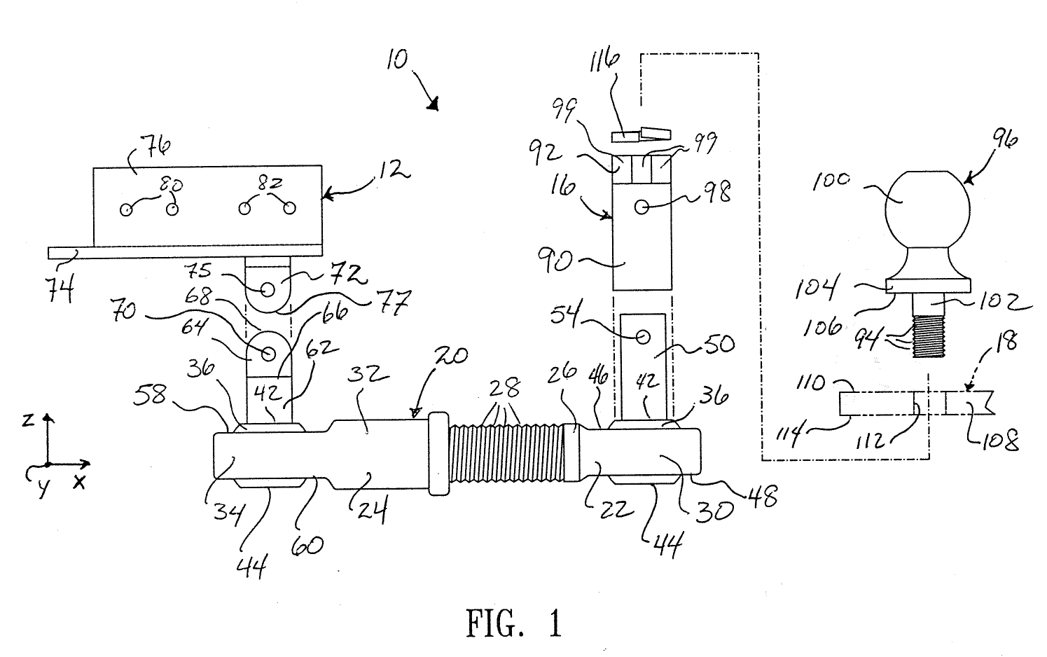

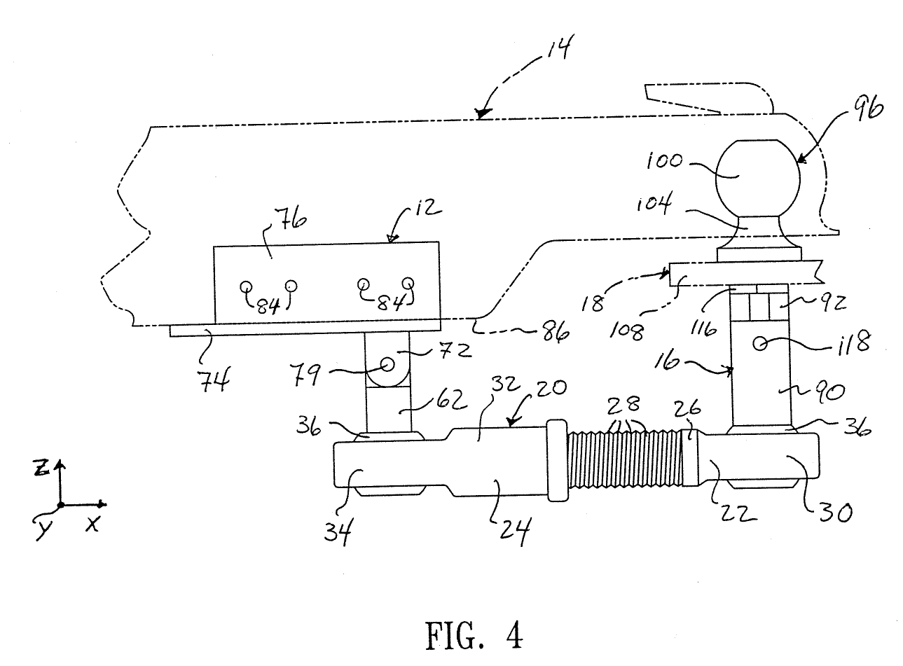

Referring now to the drawings, and to FIGS. 1 and 4 in particular, a trailer hitch safety device 10 according to the invention includes a bracket 12 for connection to a trailer tongue 14 (shown in phantom line in FIG. 4), a sleeve 16 that connects to a trailer hitch 18 (shown in phantom line), and a connecting arm 20 extending between the bracket 12 and sleeve 16.

With additional reference to FIG. 2, the connecting arm 20 includes a front arm portion 22 adjustably received within a rear arm portion 24. The front arm portion 22 includes a shaft section 26 with external threads 28 formed thereon and a ball joint section 30 that is preferably integrally formed at one end of the shaft section 26. Likewise, the rear arm portion 24 includes a shaft section 32 with internal threads (not shown) formed therein and a ball joint section 34 that is preferably integrally formed at one end of the shaft section 32. The internal threads of the shaft section 32 receive the external threads 28 of the shaft section 26 to thereby connect the front and rear arm portions 22 and 24 together. The length of the connecting arm 20 can be adjusted before mounting the trailer hitch safety device 10 between the trailer tongue 14 and trailer hitch 18 by rotating one arm portion with respect to the other arm portion while the threads are engaged. In this manner, a wide variety of trailer tongue and hitch styles can be accommodated.

The ball joint section 30 comprises a spherical bearing member 36 caged within an annular raceway or bearing cage 38 which is in turn preferably press-fit into an opening 40 formed in the ball joint section 30. As shown, the spherical bearing member 36 is truncated to form a flat upper surface 42 and a flat lower surface 44. Preferably, the upper and lower surfaces 42 and 44 extend above and below an upper surface 46 and lower surface 48, respectively, of the ball joint section 30. A bore (not shown) preferably extends through a center of the bearing member 36 from the upper surface 42 to the lower surface 44 thereof. A shaft 50 is received in the bore and is preferably welded to the spherical bearing member. In an alternative embodiment, the bearing member 36 may be integrally formed with the shaft 50 through machining, molding, or other well-known forming operations. With this arrangement, the shaft 50 rotates with the bearing member 36 about a first axis (Z-axis) of rotation that is coincident with the center axis of the shaft, and tilts about two additional axes (X-axis and Y-axis) of rotation that are perpendicular to each other and the first axis of rotation. The amount of shaft tilt in the two additional axes of rotation is limited by the shaft 50 coming into contact with the inner edge 52 of the annular raceway 38. Preferably, the amount of tilt does not interfere with normal rotational movement between the trailer tongue 14 and hitch 18 during towing. It is to be understood that the orientation of rotational axes in the X, Y and Z directions refer to relative, rather than absolute orientations. The shaft 50, the bearing member 36, and the raceway 38 can be dimensioned to allow the trailer maximum safe tilt with respect to the towing vehicle, while preventing trailer overturn. The shaft 50 is preferably cylindrical and includes an aperture 54 that extends diametrically through the shaft 50 for a purpose to be described in greater detail below.

The ball joint section 34 is constructed similarly to the ball joint section 30 and comprises a spherical bearing member 36 caged within an annular raceway or bearing cage 38 which is in turn preferably press-fit into an opening 56 formed in the ball joint section 34. As shown, the spherical bearing member 36 is truncated to form a flat upper surface 42 and a flat lower surface 44. Preferably, the upper and lower surfaces 42 and 44 extend above and below an upper surface 58 and lower surface 60, respectively, of the ball joint section 34. A bore (not shown) preferably extends through a center of the bearing member 36 from the upper surface 42 to the lower surface 44 thereof. A shaft 62 is received in the bore and is preferably welded to the spherical bearing member. In an alternative embodiment, the bearing member 36 may be integrally formed with the shaft 62 through machining, molding, or other well-known forming operations. With this arrangement, the shaft 62 rotates with the bearing member 36 about a first axis (Z-axis) of rotation that is coincident with the center axis of the shaft, and tilts about two additional axes (X-axis and Y-axis) of rotation that are perpendicular to each other and the first axis of rotation. Again, it is to be understood that the orientation of rotational axes in the X, Y and Z directions refer to relative, rather than absolute orientations. Rotation and tilt of the shaft 62 is independent of rotation and tilt of the shaft 50 before the connecting arm 20 is mounted between the tongue 14 and the trailer hitch 18.

A conventional grease fitting 55 (FIG. 2) is preferably mounted in each ball joint section 30, 34 and is in fluid communication with its respective raceway or bearing cage for permitting lubrication of the spherical bearing member and its associated raceway within the connecting arm 20. Alternatively, the ball joint sections 30, 34 may be of the sealed type, requiring no periodic lubrication. In this instance, the grease fittings may be eliminated.

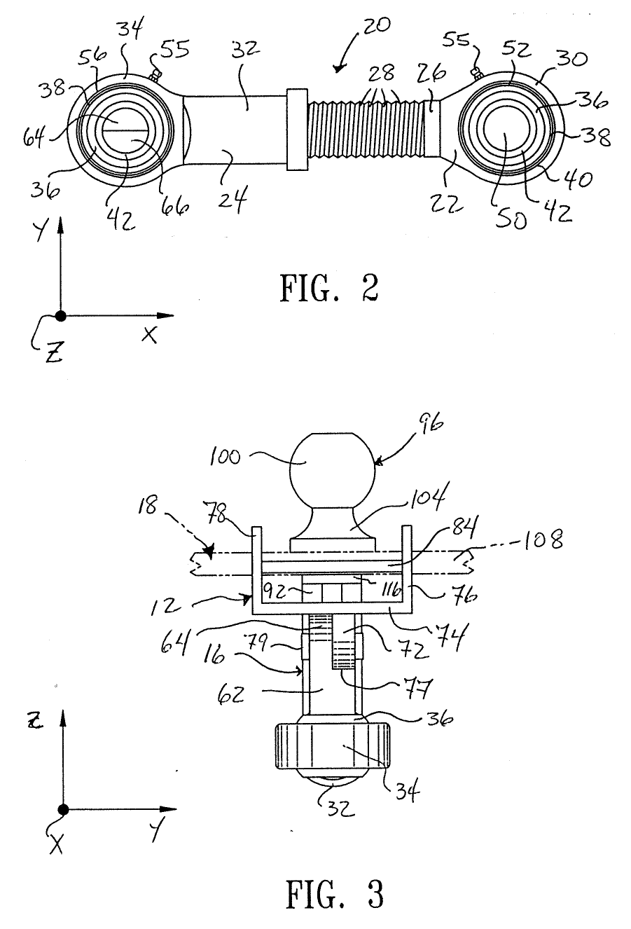

As shown in FIGS. 1 and 3, the shaft 62 is preferably cylindrical and includes a tab 64 extending upwardly from a shoulder 66. The tab 64 and shoulder 66 may be formed by machining an upper portion of the shaft 62 into a half-cylinder. The tab 65 includes an aperture 70 and a curved upper surface 68.

The bracket 12 is preferably C-shaped and includes a bottom wall 74 from which a tab 72 depends and a pair of side walls 76 and 78 extending upwardly from the bottom wall 74. The tab 72 is similar in shape to the tab 64 and includes an aperture 75 and a curved lower surface 77. The apertures 70 and 75 receive a pivot pin 79, rod, or the like for rotatably securing the shaft 62 to the bracket 12. The side walls 76 and 78 of the bracket 12 can be welded to the bottom wall 74. Alternatively, the side walls and bottom wall can be formed during an extrusion process as an integral C-channel beam and cut to the appropriate length. Two pairs of apertures 80 and 82 are formed in each side wall 76 and 78. Each aperture pair 80, 82 in the side wall 76 is aligned with a corresponding aperture pair (not shown) in the side wall 78. Corresponding sets of apertures (not shown) are also preferably formed in the trailer tongue 14.

The bracket 12 is installed on the trailer tongue 14 by positioning the bottom wall 74 against the lower surface 86 (FIG. 4) of the trailer tongue with the side walls 76 and 78 extending on either side of the tongue. A solid bar or rod 84 is then inserted through the aligned apertures 80 and 82 in the bracket 12 and corresponding apertures in the tongue 14. When it is desired to remove the bracket 12 from the trailer tongue 14, the bars or rods 84 preferably formed part of a pair of padlocks (not shown), with each padlock having a U-shaped bar that extends through one of the aligned aperture pairs 80 and 82 and is received in locking engagement with a lock portion of the padlock.

In an alternative embodiment, the bracket 12 may comprise only the bottom wall 74 and may be directly welded to the trailer tongue 14 for permanent installation. Although particular embodiments of the bracket 12 have been described, it is to be understood that other means for rigidly securing the tab 72 to the trailer tongue 86 are contemplated.

Referring again to FIGS. 1 and 4, the sleeve 16 includes a lower tubular portion 90 that receives the shaft 50, and an upper portion 92 with internal threads (not shown) for receiving the external threads 94 of a ball member 96. An aperture 98 is formed in diametrically opposite sides of the lower tubular portion 90. Engagement faces 99 are formed on the outer surface of the upper portion 92 for facilitating turning of the sleeve 16 with a wrench or the like during installation of the ball member 96 on the trailer hitch 18. In an alternative arrangement, the sleeve 16 may be formed integrally with the bearing member 36.

The ball member 96 is conventional in construction and includes a ball 100 connected to a mounting base 104. A shank 102 extends downwardly from the base and includes the external threads 94.

The ball member 96 is installed on the trailer hitch 18 by inserting the shank 102 into an opening 112 of a ball mounting plate 108 that forms part of the trailer hitch, until a lower surface 106 of the mounting base 104 rests against an upper surface 110 of the plate 108. In his manner, the external threads 94 extend below a lower surface 114 of the plate 108. A lock washer 116 is then mounted on the shank 102 and the sleeve 16 is threaded onto the shank until the mounting plate 108 is sandwiched between the mounting base 104 and the lock washer 116. The shaft 50 is then inserted into the lower tubular portion 90 until the aperture 54 of the shaft 50 is in alignment with the apertures 98 of the sleeve 16. A pin 118 (FIG. 4), such as a cotter pin or other securing means, is then inserted through the apertures 54 and 98 and secured against separation from the shaft by installing a cotter key (not shown) on the pin.

For added security, a threaded aperture (not shown) may extend radially through the threaded portion of the sleeve 16 and a set screw (now shown) may be threaded into the threaded aperture and contact the threads 94 of the ball member 96 for preventing relative rotation between the sleeve and the ball member.

If desired, a flexible cable, spring, or the like (not shown) may be connected between the bracket 12 and the connecting arm 20 to prevent downward rotation of the connecting arm when the pin 118 is removed from the shaft 50 and the sleeve 16.

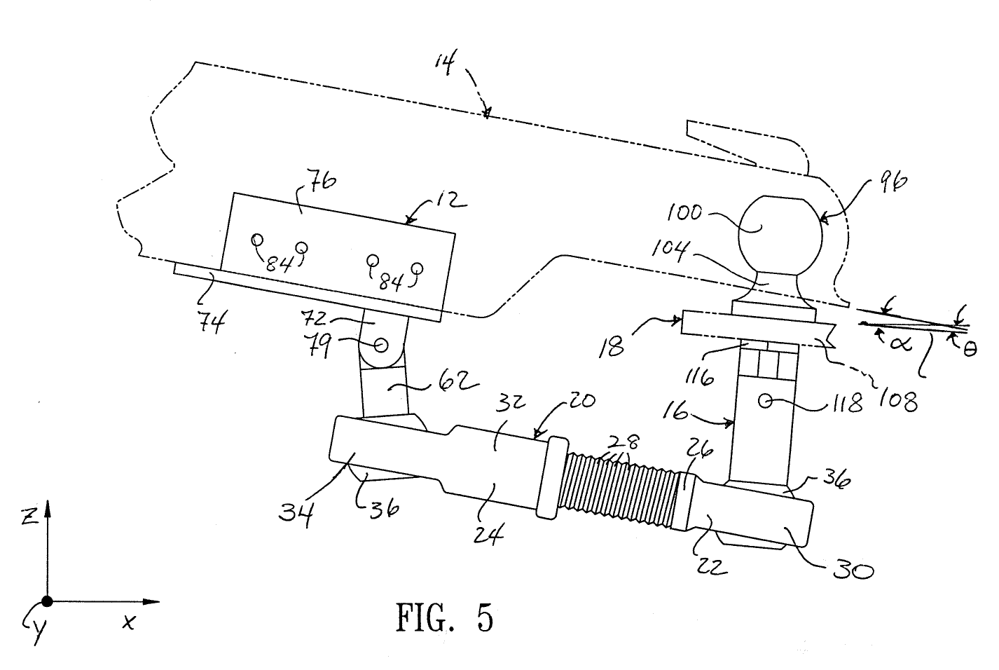

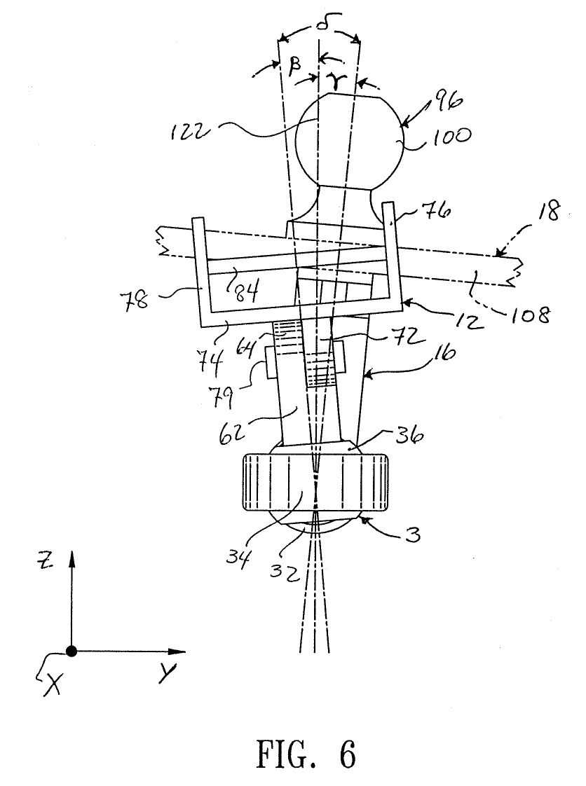

Once installed, and with further reference to FIGS. 5 and 6, the trailer hitch safety device 10 prevents the inadvertent separation of the trailer from the hitch of a vehicle, while the ball joint sections 30 and 34 at opposite ends of the connecting arm 20 permit relative rotation of the vehicle and trailer during towing. By way of example, and as shown in FIG. 5, the trailer tongue 14 is rotated at an angle α with respect to trailer hitch 18, which is in turn rotated at and angle θ with respect to a horizontal or X-axis line 120 in the X-Z plane. Such an orientation between the trailer and vehicle may occur when the trailer is arranged on one incline and the vehicle is arranged on another incline of a road surface that is parallel to a direction of vehicle travel, or when the weight on the trailer tongue causes deflection of the vehicle rear suspension. In this example, shaft 62 is rotated about pin 79 relative to tab 72 and about the bearing member 36 of the ball joint section 34 relative to the connecting arm 20. Likewise, sleeve 16 is rotated about the bearing member 36 of the ball joint section 30 relative to the connecting arm 20. Pivotal movement of the arm 62 about the pin 79 effectively lengthens and shortens the connecting arm 20 as needed, depending on the orientation of the trailer tongue 14 with respect to the hitch 18.

With particular reference to FIG. 6, the trailer tongue 14 is shown rotated at an angle δ with respect to the hitch 18, while the trailer tongue 14 and the hitch 18 are rotated at angles β and γ, respectively, with respect to a vertical or Z-axis line 122 in the Y-Z plane. Such an orientation between the trailer and vehicle may occur when the trailer is arranged on one incline and the vehicle is arranged on another incline of the road surface that is transverse to the direction of vehicle travel, or when the trailer and/or vehicle is unevenly loaded.

A combination of inclined surfaces both parallel and transverse to the direction of vehicle travel maybe encountered while towing the vehicle. The arrangement of the ball joint sections 30 and 34 at opposite ends of the connecting arm 20 permits relative rotation of the vehicle and trailer during towing when encountering such incline combinations.

While the invention has been taught with specific reference to these embodiments, those skilled in the art will recognize that changes can be made in form and detail without departing from the spirit and the scope of the invention. The described embodiments are to be considered in all respects only as illustrative and not restrictive. For example, shafts of different or varying lengths can be secured to each bearing depending on the thickness of the ball mounting plate or other variations in the trailer hitch 18 and/or tongue 14. It is also contemplated that the shaft and/or sleeve 16 can have more than one aperture for adjusting the height of this sleeve 16 from the ball joint section 30. The scope of the invention is, therefore, indicated by the appended claims rather than by the foregoing description. All changes that come within the meaning and range of equivalency of the claims are to be embraced within their scope.

The Doctrine of Equivalents is hereby relied upon to determine and assess the reasonably fair scope of the present invention as pertains to any apparatus not materially departing from but outside the literal scope of the invention as set forth in the following claims.

What is claimed is:

1. A safety device for connection between a tongue of a trailer and a hitch of a vehicle, the safety device comprising:
an elongate arm;
first and second ball joint sections located at opposite ends of the elongate arm, the first and second ball joint sections including first and second bearing cages, respectively, located in the elongate arm and first and second substantially spherical bearing members positioned within the first and second bearing cages, respectively, for rotation relative thereto;
the first spherical bearing member being adapted for connection to one of the tongue and the hitch; and
the second spherical bearing member being adapted for connection to the other of the tongue and the hitch;
whereby relative movement between the trailer tongue and hitch causes rotation of the first and second spherical bearing members.

2. A safety device according to claim 1, and further comprising a first shaft extending from the first spherical bearing member, the first shaft being adapted for securement to one of the tongue and hitch.

3. A safety device according to claim 2 and further comprising a second shaft extending from the second spherical bearing member, the second shaft being adapted for securement to the other of the tongue and hitch.

4. A safety device according to claim 3, and further comprising amounting bracket for securement to the trailer tongue, the first shaft being connected to the mounting bracket.

5. A safety device according to claim 4, wherein the mounting bracket is pivotally connected to a free end of the first shaft.

6. A safety device according to claim 4, wherein the mounting bracket is substantially U-shaped with a pair of spaced side walls extending from a bottom wall, the space between the side walls being arranged to receive the trailer tongue.

7. A safety device according to claim 3, wherein the hitch includes a ball member with a threaded shank extending from the ball member, and further comprising a sleeve connected to the second shaft, the sleeve including internal threads for mating with the threaded shank to thereby pivotally connect the second shaft to the hitch.

8. A safety device according to claim 1, wherein the elongate arm includes a first arm portion with the first ball joint section mounted therein and a second arm portion with the second ball joint section mounted therein, the first and second arm portions being relatively adjustable.

9. A safety device according to claim 8, wherein one of the first and second arm portions is telescopically received in the other of the first and second arm portions.

10. A safety device according to claim 9, wherein the first and second arm portions include mutually engageable threads such that rotation of one arm portion with respect to the other arm portion causes a change in the length of the elongate arm.

11. A safety device for connection between a tongue of a trailer and a hitch of a vehicle, the safety device comprising:
an elongate arm having a first arm portion adjustably connected to a second arm portion for adjusting a length of the elongate arm; and
a ball joint section connected to each of the first and second arm portions, each ball joint section including a bearing cage located in the respective aim portion and a bearing member positioned in the bearing cage for rotation relative thereto; and
each bearing member being adapted for connection to one of the tongue and the hitch;
whereby relative movement between the trailer tongue and hitch causes rotation of the bearing members.

12. A safety device according to claim 11, and further comprising a first shaft extending from one of the bearing members, the first shaft being adapted for securement to one of the tongue and hitch.

13. A safety device according to claim 12 and further comprising a second shaft extending from the other of the bearing members, the second shaft being adapted for securement to the other of the tongue and hitch.

14. A safety device according to claim 13, and further comprising a mounting bracket for securement to the trailer tongue, the first shaft being connected to the mounting bracket.

15. A safety device according to claim 14, wherein the mounting bracket is pivotally connected to a free end of the first shaft.

16. A safety device according to claim 14, wherein the mounting bracket is substantially U-shaped with a pair of spaced side walls extending from a bottom wall, the space between the side walls being arranged to receive the trailer tongue.

17. A safety device according to claim 13, wherein the hitch includes a ball member for connection with a socket of the trailer tongue, with a threaded shank extending from the ball member, and further comprising a sleeve connected to the second shaft, the sleeve including internal threads for mating with the threaded shank to thereby pivotally connect the second shaft to the hitch.

18. A safety device according to claim 11, wherein one of the first and second arm portions is telescopically received in the other of the first and second arm portions.

19. A safety device according to claim 18, wherein the first and second arm portions include mutually engageable threads such that rotation of one arm portion with respect to the other arm portion causes a change in the length of the elongate arm.

20. A safety device according to claim 11, wherein the bearing members are substantially spherical.
